(19) United States
(12) Patent Application Publication
(10) Pub. No.: US 2026/0157373 A1
(43) Pub. Date: Jun. 11, 2026

(54) HERBICIDAL COMPOSITIONS AND METHODS FOR CONTROLLING WEEDS

(71) Applicant: UPL Mauritius Limited, Port Louis (MU)

(72) Inventors: Ryan Henry, Durham, NC (US); Cody Gray, Durham, NC (US); Prakash Mahadeo Jadhav, Audubon, PA (US); Stephen Skorczynski, Audubon, PA (US); Vraj Patel, Audubon, PA (US)

(21) Appl. No.: 19/413,097

(22) Filed: Dec. 9, 2025

Related U.S. Application Data
(60) Provisional application No. 63/730,189, filed on Dec. 10, 2024.

(51) Int. Cl. A01N 47/38; A01N 41/10; A01N 43/80; A01P 13/00

(52) U.S. Cl. CPC A01N 47/38; A01N 41/10; A01N 43/80; A01P 13/00

(57) ABSTRACT

Disclosed herein are herbicidal compositions comprising a triazolone herbicide and at least a second herbicide, wherein the second herbicide is selected from the group consisting of triketone herbicide, pyrazole herbicide, isoxazole herbicide, or a combination thereof. Further, methods of preparing the herbicidal compositions and controlling weeds comprising applying the herbicidal compositions are also disclosed.

### CROSS REFERENCE TO RELATED APPLICATION

The present application claims the benefit of and priority to U.S. Patent Application No. 63/730,189, filed on Dec. 10, 2024, the contents of which are incorporated by reference in their entirety herein.

### TECHNICAL FIELD

The present disclosure relates to an herbicidal composition comprising a triazolone herbicide and at least a second herbicide selected from the group of triketone herbicide, pyrazole herbicide, isoxazole herbicide, or a combination thereof. Further, the present disclosure relates to a process for preparing herbicidal composition and method of use thereof.

### BACKGROUND OF INVENTION

Crop protection requires constant monitoring of the sown crop for various pests. Further, weeds are a persistent problem that needs constant monitoring. Weed growth is generally controlled or suppressed by using herbicides at either the pre-plant stages or after sowing or both depending on the weed type and the level of infestation. Current practices include combining herbicides that have different modes of action, which allows for broader spectrum of control and allow for resistance management. The combinations used currently do not effectively handle resistant and persistent weeds. There is therefore a need in the art for improved combinations with enhanced efficacy and a broader spectrum of weed control.

Combinations of herbicides are used to control a broader range of weeds. However, the combination of herbicides may not always result in the desired effect. Combination of herbicides may lead to an additive effect or an antagonistic effect. It may also result in phytotoxicity to the crops making it an undesirable combination. Thus, it is vital to select herbicides that can be combined to offer an effective control of weeds while having no phytotoxic effect on the crop and reduce the chances of development of herbicide resistant weeds.

Compositions containing combinations of two or more herbicides have been known in the art, but problems such as the physical instability of such mixtures during manufacture, shelf life or dilution at the time of application in the field, can adversely impact the efficacy associated with the herbicide combination.

In addition to selection of the appropriate herbicides, it is important to identify the appropriate formulation type for the specific combination of herbicides. Suspension concentrate (SC) formulations, for example, are a solid active ingredient dispersed in water. SCs have grown in popularity due to benefits such as absence of dust, ease of use and effectiveness when compared to formulation types such as emulsifiable concentrate (EC) and wettable powder (WP) formulations. To formulate a stable SC, the active ingredient must remain insoluble and suspended under all temperature conditions throughout shelf-life.

Several problems arise when active ingredients are to be formulated as suspension concentrates. A major drawback of formulating a slightly water-soluble ingredient as an aqueous SC is Ostwald ripening, which refers to instances in which the larger crystals of the ingredient grow while the smaller crystals dissolve. Ostwald ripening is generally facilitated by dissolution of the active substances into the continuous aqueous phase, which can occur even if the solubility of the active substances in water is low. However, high solubility of the active substances in water increases the incidence of Ostwald ripening for active substances that are capable of Ostwald ripening. Physical instability is one manifestation of Ostwald ripening. Further, drawbacks to Ostwald ripening include limited utility of the formulation because an acceptable shelf-life may not be obtained. For instance, a two-year shelf-life is typically needed for a successful commercial product in agrochemicals. Also, crystals that grow too large may plug spray equipment and may not stay suspended in the spray tank or concentrated formulation. Gelling, caking, and settling due to large crystals being formed in the final suspension concentrate formulation result in instability, difficulty in processing and unreliability in usage impacting the efficacy of the product.

Thus, formulating suspension concentrate compositions of a triazolone herbicide and at least a second herbicide, such as, a triketone herbicide, a pyrazole herbicide, an isoxazole herbicide, wherein this gelling, caking, and settling are minimized is crucial to the stability of suspension concentrates which is then necessary to obtain an even distribution of active compounds for application. Selection of appropriate partners/constituents constituting the suspension concentrate plays a critical role towards stability of the composition.

Therefore, there is a need to develop a stable agrochemical composition which do not undergo crystal formation of the active and remain stable throughout the shelf life as well as during application in field.

### SUMMARY OF INVENTION

In an embodiment, the present disclosure provides an herbicidal composition comprising:
a. at least one triazolone herbicide,
b. at least one herbicide selected from the group consisting of triketone herbicide, pyrazole herbicide, isoxazole herbicide, or a combination thereof, and
c. at least a crystal growth inhibitor

In another embodiment, the triazolone herbicide is selected from the group comprising amicarbazone, bencarbazone, carfentrazone, flucarbazone, ipfencarbazone, propoxycarbazone, sulfentrazone, and thiencarbazone. In a preferred embodiment, the triazolone herbicide is amicarbazone.

In yet another embodiment, the triketone herbicide is selected from the group consisting of benquitrione, benzobicyclon, bicyclopyrone, dioxopyritrione, fenquinotrione, ketospiradox, lancotrione, mesotrione, quintrione, sulcotrione, tefuryltrione, and Tembotrione. In a preferred embodiment, the triketone herbicide is mesotrione.

In yet another embodiment, the pyrazole herbicide is selected from the group consisting of benzofenap, bipyrazone, cypyrafluone, fenpyrazone, pyraquinate, pyrasulfotole, pyrazolynate, pyrazoxyfen, tolpyralate, topramezone, and tripyrasulfone. In a preferred embodiment, the pyrazole herbicide is topremazone. In a preferred embodiment, the triketone herbicide is mesotrione.

In yet another embodiment, the isoxazole herbicide is selected from the group consisting of isoxacarbole, isoxachlortole, and Isoxaflutole. In a preferred embodiment, the isoxazole herbicide is isoxaflutole.

In yet another embodiment, the herbicidal composition described herein is in the form of a suspension concentrate.

In yet another embodiment, the instant disclosure provides a process for preparing an herbicidal composition described herein.

In yet another embodiment, the instant disclosure provides a method controlling weeds at a locus, the method comprising applying to the locus an herbicidal composition described herein.

Furthermore, the present disclosure provides a method of controlling chlorotriazine resistant or tolerant weeds comprising applying an herbicidal composition described above.

### DETAILED DESCRIPTION OF INVENTION

For the purposes of the following detailed description, it is to be understood that the invention may assume various alternative variations, except where expressly specified to the contrary. Moreover, other than in any operating examples, or where otherwise indicated, all numbers expressing, for example, quantities of materials/ingredients used in the specification are to be understood as being modified in all instances by the term “about”. The term “about” used to qualify the amounts of active components shall be interpreted to mean “approximately” or “reasonably close to” and any statistically insignificant variations therefrom.

As used herein, the terms “comprising” “including,” “having,” “containing,” “involving,” and the like are to be understood to be open-ended, i.e., to mean including but not limited to.

In any aspect or embodiment described hereinbelow, the phrase comprising may be replaced by the phrases “consisting of” or “consisting essentially of”. In these aspects or embodiment, the combination or formulation described includes or comprises or consists of or consists essentially of or consists substantially of the specific components recited therein, to the exclusion of other ingredients or excipients not specifically recited therein.

The term “herbicide” as used herein, shall mean an active ingredient that kills, controls or otherwise adversely modifies the growth of weeds. As used herein, an herbicidally effective or vegetation controlling amount is an amount of active ingredient that causes an “herbicidal effect,” i.e., an adversely modifying effect and includes deviations from natural development, killing, regulation, desiccation, retardation.

The term phytotoxicity as used herein refers to adverse effects on plant growth, physiology, or metabolism caused by an herbicide.

As used herein, a herbicidally effective or vegetation controlling amount is an amount of active ingredient that causes a “herbicidal effect,” i.e., an adversely modifying effect and includes deviations from natural development, killing, regulation, desiccation, retardation stunting, dwarfing and the like.

The terms “plants” and “vegetation” include, but are not limited to, germinant seeds, emerging seedlings, plants emerging from vegetative propagules, and established vegetation.

The terms “undesirable vegetation”, “harmful plants”, “unwanted plants”, “weeds” and “weed species”, as used herein, are synonyms.

The term “locus” as used herein shall denote the vicinity of a desired crop in which weed control, typically selective weed control is desired. The locus includes the vicinity of desired crop plants wherein the weed infestation has either emerged or is yet to emerge.

The term “crop” shall include a multitude of desired crop plants or an individual crop plant growing at a locus.

The term ‘D50’ indicates that the particle size at which 50% of the sample's particles (by volume or mass) are smaller and 50% are larger. It is referred to as the median particle size and is a key indicator of the central tendency of the particle size distribution.

The term ‘D90’ indicates the particle size below which 90% of the sample's particles fall. In other words, only 10% of the particles are larger than this size.

References to the term g ai/ha or g A/ha refer to grams of active ingredient per hectare of area.

Each of the aspects described above may have one or more embodiments.

Each of the embodiments described hereinafter may apply to one or all of the aspects described hereinabove. These embodiments are intended to be read as being preferred features of one or all of the aspects described hereinabove. Each of the embodiments described hereinafter applies to each of the aspects described hereinabove individually.

The inventors of the instant application surprisingly found that a storage stable agrochemical formulation comprising a triazolone herbicide and at least a second herbicide can be formulated with a crystal growth inhibitor. The inventors of the instant application surprisingly found that the formulation developed using a combination of a crystal growth inhibitor, surfactant and dispersion agents, as described herein, remained stable during ambient as well as accelerated heat stability test conditions. Thus, the instant application provides a storage stable agrochemical formulation, wherein the combination of a crystal growth inhibitor, surfactant and dispersion agents do not favor Ostwald ripening, and the formulation remains stable throughout the shelf life and upon dilution before applying in the field.

Further, the inventors of the present application surprisingly found that the herbicidal composition described herein results in an effective control of undesirable plants, at the locus of the desired plant, controls the growth of weeds, and reduces phytotoxicity in crop plants.

In an embodiment, the present disclosure provides an herbicidal composition comprising:
a. at least one triazolone herbicide,
b. at least a second herbicide selected from the group consisting of triketone herbicide, pyrazole herbicide, isoxazole herbicide, or a combination thereof, and
c. at least a crystal growth inhibitor.

In an embodiment, the present disclosure provides an herbicidal composition comprising:
a. at least one triazolone herbicide,
b. at least a second herbicide selected from the group consisting of triketone herbicide, pyrazole herbicide, isoxazole herbicide, or a combination thereof,
c. at least a crystal growth inhibitor, and
d. at least an agriculturally acceptable excipient.

In another embodiment, the triazolone herbicide is selected from the group comprising amicarbazone, bencarbazone, carfentrazone, flucarbazone, ipfencarbazone, propoxycarbazone, sulfentrazone, and thiencarbazone. In a preferred embodiment, the triazolone herbicide is amicarbazone.

In yet another embodiment, the triketone herbicide is selected from the group consisting of benquitrione, benzobicyclon, bicyclopyrone, dioxopyritrione, fenquinotrione, ketospiradox, lancotrione, mesotrione, quintrione, sulcotrione, tefuryltrione, and Tembotrione. In a preferred embodiment, the triketone herbicide is mesotrione.

In yet another embodiment, the pyrazole herbicide is selected from the group consisting of benzofenap, bipyrazone, cypyrafluone, fenpyrazone, pyraquinate, pyrasulfotole, pyrazolynate, pyrazoxyfen, tolpyralate, topramezone, and tripyrasulfone. In a preferred embodiment, the pyrazole herbicide is topremazone.

In yet another embodiment, the isoxazole herbicide is selected from the group consisting of isoxacarbole, isoxachlortole, and isoxaflutole. In a preferred embodiment, the isoxazole herbicide is isoxaflutole.

In another embodiment, the present disclosure provides an herbicidal composition comprising at least one triazolone herbicide and at least one triketone herbicide.

In another embodiment, the present disclosure provides an herbicidal composition comprising at least one triazolone herbicide and at least one pyrazole herbicide.

In another embodiment, the present disclosure provides an herbicidal composition comprising at least one triazolone herbicide and at least one isoxazole herbicide.

In one embodiment, the present disclosure provides an herbicidal composition comprising:
a. at least one triazolone herbicide;
b. at least one triketone herbicide; and
c. at least a crystal growth inhibitor.

In another embodiment, the present disclosure provides an herbicidal composition comprising:
a. at least one triazolone herbicide;
b. at least one triketone herbicide;
c. at least a crystal growth inhibitor;
d. at least one anionic surfactant; and
e. at least one agriculturally acceptable excipient.

In yet another embodiment, the present disclosure provides an herbicidal composition comprising:
a. amicarbazone;
b. at least one triketone herbicide;
c. at least a crystal growth inhibitor;
d. at least one anionic surfactant; and
e. at least one agriculturally acceptable excipient.

In yet another embodiment, the present disclosure provides an herbicidal composition comprising:
a. at least one triazolone herbicide;
b. at least one pyrazole herbicide; and
c. a crystal growth inhibitor.

In yet another embodiment, the present disclosure provides an herbicidal composition comprising:
a. at least one triazolone herbicide;
b. at least one pyrazole herbicide;
c. a crystal growth inhibitor;
d. at least one anionic surfactant; and
e. at least one agriculturally acceptable excipient.

In yet another embodiment, the present disclosure provides an herbicidal composition comprising:
a. amicarbazone;
b. at least one pyrazole herbicide;
c. a crystal growth inhibitor;
d. at least one anionic surfactant; and
e. at least one agriculturally acceptable excipient.

In yet another embodiment, the present disclosure provides an herbicidal composition comprising:
a. at least one triazolone herbicide;
b. at least one isoxazole herbicide; and
c. at least a crystal growth inhibitor.

In yet another embodiment, the present disclosure provides an herbicidal composition comprising:
a. at least one triazolone herbicide;
b. at least one isoxazole herbicide;
c. a crystal growth inhibitor;
d. at least one anionic surfactant; and
e. at least one agriculturally acceptable excipient.

In yet another embodiment, the present disclosure provides an herbicidal composition comprising:
a. amicarbazone;
b. at least one isoxazole herbicide; and
c. at least a crystal growth inhibitor.

In yet another embodiment, the present disclosure provides an herbicidal composition comprising:
a. amicarbazone;
b. at least one isoxazole herbicide;
c. at least a crystal growth inhibitor;
d. at least one anionic surfactant; and
e. at least one agriculturally acceptable excipient.

In an embodiment the triazolone herbicide is selected from the group comprising amicarbazone, bencarbazone, carfentrazone, flucarbazone, ipfencarbazone, propoxycarbazone, sulfentrazone, and thiencarbazone.

In a preferred embodiment, the triazolone herbicide is amicarbazone.

In an embodiment, the triketone herbicide is selected from the group consisting of benquitrione, benzobicyclon, bicyclopyrone, dioxopyritrione, fenquinotrione, ketospiradox, lancotrione, mesotrione, quintrione, sulcotrione, tefuryltrione, and tembotrione.

In a preferred embodiment, the triketone herbicide is mesotrione.

An embodiment of the present disclosure provides a herbicidal composition comprising:
a. amicarbazone;
b. at least a second herbicide selected from mesotrione, topramezone, or isoxaflutole; and
c. at least one crystal growth inhibitor;
   wherein the composition is storage-stable and formulated as a suspension concentrate.

In an embodiment, the triazolone herbicide and triketone herbicide are present in a ratio ranging from 1:10 to 10:1. In an embodiment, the triazolone herbicide and triketone herbicide are present in a ratio ranging from 1:5 to 5:1. In an embodiment, the triazolone herbicide and triketone herbicide are present in a ratio ranging from 1:2.5 to 2.5:1. In an embodiment, the triazolone herbicide and triketone herbicide are present in a ratio ranging from 1.5:1 to 1:1.5. In another embodiment the ratio of the triazolone herbicide to the triketone herbicide is 1.50:1. In one aspect of an embodiment described herein, the ratio of the triazolone herbicide to the triketone herbicide is 1.75:1. In one aspect of an embodiment described herein, the ratio of the triazolone herbicide to the triketone herbicide is 2:1. In yet another aspect of an embodiment described herein, the ratio of the triazolone herbicide to the triketone herbicide is 2.25:1. In yet another aspect of an embodiment described herein, the ratio of the triazolone herbicide to the triketone herbicide is 2.5:1. In yet another aspect of an embodiment described herein, the ratio of the triazolone herbicide to the triketone herbicide is 2.75:1. In yet another aspect of an embodiment described herein, the ratio of the triazolone herbicide to the triketone herbicide is 3:1. In yet another aspect of an embodiment described herein, the ratio of the triazolone herbicide to the triketone herbicide can range between any pair of the preceding values, such as 2.25:1 to 3:1, 2:1 to 3:1, or 2.5:1 to 3:1.

In an embodiment, the herbicidal composition comprises a triazolone herbicide in an amount ranging from 10% w/w to 50% w/w of the total weight of the composition. In some embodiments, the triazolone herbicide is present in an amount of 10% w/w, 11%, 12%, 13% 14%, 15%, 16%, 17%, 18%, 19%, 20%, 21% w/w, 22% w/w, 23% w/w, 24% w/w, 25% w/w, 26% w/w, 27% w/w, 28% w/w, 29% w/w, 30% w/w, 31% w/w, 32% w/w, 33% w/w, 34% w/w, 35% w/w, 36% w/w, 37% w/w, 38% w/w, 39% w/w, 40% w/w, 41% w/w, 42% w/w, 43% w/w, 44% w/w, 45% w/w, 46% w/w, 48% w/w, 49% w/w, or 50% w/w of the total weight of the composition, or in an amount within any range defined between any pair of the preceding values, such as 10% w/w to 45% w/w, 15% w/w to 35% w/w, 20% w/w to 30% w/w or 27% w/w to 31% w/w of the total weight of the composition.

In an embodiment, the herbicidal composition comprises second herbicide in an amount ranging from about 1% w/w to about 90% w/w of the total weight of the composition. In another embodiment, the herbicidal composition comprises second herbicide in an amount ranging from about 1% w/w to about 70% w/w of the total weight of the composition. In another embodiment, the herbicidal composition comprises second herbicide in an amount ranging from about 1% w/w to about 50% w/w of the total weight of the composition. In another embodiment, the herbicidal composition comprises second herbicide in an amount ranging from about 1% w/w to about 30% w/w of the total weight of the composition. In another embodiment, the herbicidal composition comprises second herbicide in an amount ranging from about 1% w/w to about 20% w/w of the total weight of the composition. In another embodiment, the herbicidal composition comprises second herbicide in an amount ranging from about 1% w/w to about 10% w/w of the total weight of the composition.

In an embodiment, the herbicidal composition comprises a triketone herbicide in an amount ranging from 5% w/w to 20% w/w of the total weight of the composition. In some embodiments, the triketone herbicide is present in an amount of 5% w/w, 6% w/w, 7% w/w, 8% w/w, 9% w/w, 10% w/w, 11% w/w, 12% w/w, 13% w/w, 14% w/w, 15% w/w, 16% w/w, 17% w/w, 18% w/w, 19% w/w or 20% w/w of the total weight of the composition, or in an amount within any range defined between any pair of the preceding values, such as 10% w/w to 20% w/w, or 12% w/w to 15% w/w of the total weight of the composition.

In an embodiment, the pyrazole herbicide is selected from the group consisting of benzofenap, bipyrazone, cypyrafluone, fenpyrazone, pyraquinate, pyrasulfotole, pyrazolynate, pyrazoxyfen, tolpyralate, topramezone, and tripyrasulfone.

In a preferred embodiment, the pyrazole herbicide is topramezone.

In an embodiment, the triazolone herbicide and pyrazole herbicide, in the herbicidal composition are present in a ratio ranging from 1:1 to 10:1. In one aspect of an embodiment described herein, the ratio of the triazolone herbicide to the pyrazole herbicide is 1.00:1, 1.50:1, 2.00:1, 2.50:1, 3.00:1, 3.50:1, 4.00:1, 4.50:1, 4.75:1, 5.00:1, 5.50:1, 6.00:1, 6.50:1, 7.00:1, 7.50:1, 8.00:1, 8.50:1, 9.00:1, 9.50:1, or 10.00:1, any pair of the preceding values, such as 6.00:1 to 9.00:1, 6.50:1 to 8.50:1, or 6.50:1 to 8.5:1.

In an embodiment, an herbicidal composition described herein comprises a pyrazole herbicide in an amount ranging from 5% w/w to 20% w/w of the total weight of the composition. In some embodiments, the triketone herbicide is present in an amount of 5% w/w, 6% w/w, 7% w/w, 8% w/w, 9% w/w, 10% w/w, 11% w/w, 12% w/w, 13% w/w, 14% w/w, 15% w/w, 16% w/w, 17% w/w, 18% w/w, 19% w/w or 20% w/w of the total weight of the composition, or in an amount within any range defined between any pair of the preceding values, such as 10% w/w to 20% w/w, or 12% w/w to 15% w/w of the total weight of the composition.

In an embodiment, the isoxazole herbicide is selected from the group consisting of isoxacarbole, isoxachlortole, and isoxaflutole.

In a preferred embodiment, the isoxazole herbicide is isoxaflutole.

In an embodiment, the triazolone herbicide and isoxazole herbicide, in the herbicidal composition are present in a ratio ranging from 1:10 to 10:1. In one aspect of an embodiment described herein, the ratio of the triazolone herbicide to the pyrazole herbicide is 1:1, 2:1, 3:1, 4:1, 5:1, 6:1, 7:1, 8:1, 9:1, 10:1, 1:2, 3:2, 5:2, 7:2, 9:2, 1:2.5, 2:2.5, 3:2.5, 4:2.5, 6:2.5, 7:2.5, 8:2.5, or 9:2.5 any pair of the preceding values, such as 1:1 to 10:2, or 5:1 to 10:1.

In an embodiment, an herbicidal composition described herein comprises an isoxazole herbicide in an amount ranging from 10% w/w to 50% w/w of the total weight of the composition. In some embodiments, the isoxazole herbicide is present in an amount of 10% w/w, 11%, 12%, 13% 14%, 15%, 16%, 17%, 18%, 19%, 20%, 21% w/w, 22% w/w, 23% w/w, 24% w/w, 25% w/w, 26% w/w, 27% w/w, 28% w/w, 29% w/w, 30% w/w, 31% w/w, 32% w/w, 33% w/w, 34% w/w, 35% w/w, 36% w/w, 37% w/w, 38% w/w, 39% w/w, 40% w/w, 41% w/w, 42% w/w, 43% w/w, 44% w/w, 45% w/w, 46% w/w, 48% w/w, 49% w/w, or 50% w/w of the total weight of the composition, or in an amount within any range defined between any pair of the preceding values, such as 10% w/w to 45% w/w, 15% w/w to 35% w/w, 20% w/w to 30% w/w or 27% w/w to 31% w/w of the total weight of the composition.

In an embodiment, an herbicidal composition comprises at least one co-polymer dispersant as a crystal growth inhibitor. In an embodiment, the present composition comprising crystal growth inhibitor in an amount ranging from 1% w/w to 20% w/w of the total weight of the formulation. In some embodiments, the crystal growth inhibitor is present in an amount of 1.0% w/w, 2.0% w/w, 3% w/w, 4% w/w, 5.0% w/w, 6% w/w, 7% w/w, or 8% w/w of the total weight of the composition, or in an amount within any range defined between any pair of the preceding values, such as 5.0% w/w to 8.0% w/w, or 6.0% w/w to 7.0% w/w of the total weight of the composition.

In some embodiments, the crystal growth inhibitor is an acrylic co-polymer. In an embodiment, acrylic co-polymer is present in compositions from about 1% to about 20% w/w of the total weight of the composition. In an embodiment, acrylic co-polymer is present in compositions at a concentration from about 1% to about 15% w/w of the total weight of the composition. In an embodiment, acrylic co-polymer is present in compositions at a concentration from about 1% to about 10% w/w of the total weight of the composition. In an embodiment, acrylic co-polymer is present in compositions at a concentration from about 2% to about 8% w/w of the total weight of the composition.

In an embodiment, acrylic copolymer is Envipol® TRN

In an embodiment the present composition comprises a surfactant component. In an embodiment the surfactant component comprises a graft copolymer and polyalkylene oxide block copolymer.

The graft copolymer surfactant is present in an amount from about 1% to about 10% w/w of the total weight of the composition. In another embodiment, the graft copolymer is present in an amount from about 1% to about 5% w/w of the total weight of the composition. The polyalkylene oxide block copolymer is present in an amount from about 0.1% to about 10% w/w of the total weight of the composition. The polyalkylene oxide block copolymer in compositions of the present invention is present in an amount from about 0.1% to about 5% w/w of the total weight of the composition. The polyalkylene oxide block copolymer is present in an amount from about 0.1% to about 2% w/w of the total weight of the composition. In one embodiment the graft copolymer is polymethyl methacrylate-polyethylene glycol graft copolymer.

In an embodiment, an agrochemical composition further comprises one or more agriculturally acceptable excipient selected from surfactants, wetting agents, antifreezing agents, carriers, diluents, fillers, solvents, stabilizers, thickeners, preservatives, biocides, antifoaming agents, colorants, and other formulation aids.

In an embodiment, wetting agents are non-ionic wetting agents selected from alkyl phenol ethoxylates, fatty alcohol alkoxylate, polyoxethylene esters of fatty acids, methyl ester ethoxylates, polyalkylene oxide block co-polymers, alkyl amine ethoxylates, fatty alkanolamides, alkyl amine oxides, esters of polyhydric alcohols and fatty acids, glycol esters, ethoxylated glycerol esters, polyglycerol esters, anhydrohexitol esters, polyoxyalkylene polyol esters, alkyl poly glucosides, gemini surfactants, poly(ethylene oxide)-poly(propylene oxide)-poly(ethylene oxide) block copolymer, silicone-based surfactants like siloxane polyethers, polyvinyl alcohol polyoxyethylene alkyl ether, oxirane, 2-methyl polymer with oxirane, mono(2-propylheptyl) ether, acrylate copolymer, tristyryl phenol ethoxylate, Guerbet alcohol alkoxylate, Oxo alcohol ethoxylates, End cap fatty alcohol polyglycerol ethers, triethanol amine ethoxylates, Ethylenediamine ethoxylate and propoxylate, Bis phenol ethoxylate, Caster oil ethoxylate, Card phenol ethoxylate, Ethoxylated Sorbitan ester, Guerbet alcohol alkoxylate end capped, fatty alcohol alkoxylate end capped, Coco amido propyl amine oxide, alkyl amido propyl betaine, Polyglycol ether of aliphatic diols, lauramide monoethanolamide, sophorolipids and rhaminolipids based surfactants, alkyl polypentosides with fatty alcohol.

In an embodiment, the concentration of agriculturally acceptable excipient is in the range from about 0.01% w/w to about 90% w/w of the total weight of the composition. In an embodiment, the concentration of agriculturally acceptable excipient is in the range from about 1% w/w to about 80% w/w of the total weight of the composition. In an embodiment, the concentration of agriculturally acceptable excipient is in the range from about 1% w/w to about 70% w/w of the total weight of the composition. In an embodiment, the concentration of agriculturally acceptable excipient is in the range from about 1% w/w to about 60% w/w of the total weight of the composition. In an embodiment, the concentration of agriculturally acceptable excipient is in the range from about 1% w/w to about 50% w/w of the total weight of the composition.

In an embodiment, the agriculturally acceptable dispersing agents are selected from alkoxylated tristyryl phenol phosphates, tristyryl phenol ethoxylated (POE-16) phosphate ester, polyacrylates, alkylarylsulfonic acid salts, dialkylsulfosuccinate salts, ether sulfates and phosphate esters. In an embodiment, the dispersing agents are used in an amount from about 1% to about 10% w/w, preferably from about 1% to about 5% w/w of the total weight of the composition.

In an embodiment, water may be present in compositions of the present invention at a concentration from about 1% to about 99% w/w, preferably from about 10% to about 80% w/w, more preferably from about 10% to about 70% w/w and even more preferably from about 10% to about 60% w/w and most preferably between about 30% to 50% w/w the total weight of the composition.

In one embodiment, the thickeners or rheology modifier suitable for use in the present invention include, but are not limited to, hydroxyethyl cellulose, magnesium aluminum silicate, attapulgite clay, hydrophilic fumed silica, aluminum oxide, xanthan gum and mixtures thereof.

Thickeners may be present in compositions of the present invention at a concentration from about 0.01% to about 5% w/w, preferably from about 0.01% to about 2% w/w, more preferably form about 0.01% to about 1% w/w the total weight of the composition.

In some embodiments, the antifoaming agent is selected from polydimethylsiloxane, silicone oil and magnesium stearate or a suitable combination thereof.

Anti-foam agents may be present in compositions of the present invention at a concentration from about 0.01% to about 1% w/w, preferably from about 0.05% to about 0.5% w/w, more preferably form about 0.2% to about 0.4% w/w and even more preferably at about 0.2% w/w of the total weight of the composition.

In some embodiments, preservatives suitable for use in the present invention include, but are not limited to, 2-bromo-2-nitro-1,3-propanediol, 5-chloro-2-methyl-4-isothiazolin-3-one and 2-methyl-4-isothiazolin-3-one solution in water, 2-benzisothiazolin-3-one and mixtures thereof. The preservative can be present in compositions of the present invention at a concentration from about 0.01% to about 5% w/w, preferably from about 0.1% to about 5% w/w, more preferably form about 0.1% to about 1% w/w and even more preferably at about 0.2% w/w of the total weight of the composition.

In some embodiments, the antifreeze agent is selected from polyols, propylene glycol or other low molecular weight alcohols. In an embodiment the antifreeze agent is glycerin. The antifreeze agent can be present in compositions of the present invention at a concentration from about 1% to about 10% w/w, preferably from about 1% to about 8% w/w of the total weight of the composition.

In an embodiment, the present herbicidal composition comprises amicarbazone as a triazolone herbicide, mesotrione as a triketone herbicide, at least a crystal growth inhibitor and at least one agriculturally acceptable excipient.

In another embodiment, the present herbicidal composition comprises amicarbazone as a triazolone herbicide, topremazone as a pyrazole herbicide, at least a crystal growth inhibitor and at least one agriculturally acceptable excipient.

In yet another embodiment, the present herbicidal composition comprises amicarbazone as a triazolone herbicide, isoxaflutole as an isoxazole herbicide, at least a crystal growth inhibitor and at least one agriculturally acceptable excipient.

In some embodiments, the present herbicidal composition comprises:
a. amicarbazone,
b. mesotrione,
c. an acrylic copolymer, and
d. at least one agriculturally acceptable excipient.

In some embodiments, the present herbicidal composition comprises:
a. amicarbazone;
b. at least a second herbicide selected from mesotrione, topramezone, or isoxaflutole;
c. at least one crystal growth inhibitor; and
d. at least an agriculturally acceptable excipient.

In some embodiments, the present herbicidal composition comprises:
a. amicarbazone,
b. topramezone,
c. an acrylic copolymer and
d. at least one agriculturally acceptable excipient.

In some embodiments, the present herbicidal composition comprises:
a. amicarbazone,
b. isoxaflutole,
c. an acrylic copolymer, and
d. at least an agriculturally acceptable excipient.

In some embodiments, the present herbicidal composition comprises:
a. amicarbazone,
b. mesotrione,
c. an acrylic copolymer,
d. polyalylene oxide block copolymer,
e. a graft copolymer based dispersant, and
f. at least an agriculturally acceptable excipient.

In some embodiments, the present herbicidal composition comprises:
a. amicarbazone,
b. topremazone,
c. an acrylic copolymer,
d. polyalylene oxide block copolymer,
e. a graft copolymer based dispersant, and
f. at least an agriculturally acceptable excipient.

In some embodiments, the present herbicidal composition comprises:
a. amicarbazone,
b. isoxaflutole,
c. an acrylic copolymer,
d. polyalkylene oxide block copolymer,
e. a graft copolymer based dispersant, and
f. at least an agriculturally acceptable excipient.

In an embodiment, the present composition is formulated as a suspension concentrate.

In an embodiment, the present invention provides a suspension concentrate comprising:
a. amicarbazone,
b. meostrione,
c. at least a crystal growth inhibitor, and
d. at least an agriculturally acceptable excipient.

In an embodiment, the present invention provides a suspension concentrate comprising:
a. amicarbazone,
b. topremazone,
c. at least a crystal growth inhibitor, and
d. at least an agriculturally acceptable excipient.

In an embodiment, the present invention provides a suspension concentrate comprising:
a. amicarbazone,
b. isoxaflutole,
c. at least a crystal growth inhibitor, and
d. at least an agriculturally acceptable excipient.

In an embodiment, the present invention provides a suspension concentrate comprising:
a. amicarbazone,
b. mesotrione,
c. an acrylic copolymer, and
d. at least an agriculturally acceptable excipient.

In an embodiment, the present invention provides a suspension concentrate comprising:
a. amicarbazone,
b. topremazone,
c. an acrylic copolymer, and
d. at least an agriculturally acceptable excipient.

In an embodiment, the present invention provides a suspension concentrate comprising:
a. amicarbazone,
b. isoxaflutole,
c. an acrylic copolymer, and
d. at least an agriculturally acceptable excipient.

In an embodiment, the present invention provides a suspension concentrate comprising 1% to about 50% w/w of amicarbazone, 5% to about 30% w/w of mesotrione, 1% to about 20% w/w of acrylic copolymer of the total weight of the composition and an agriculturally acceptable excipient.

In an embodiment, the present invention provides a suspension concentrate comprising 1% to about 50% w/w of amicarbazone, 5% to about 30% w/w of mesotrione, 1% to about 20% w/w of acrylic copolymer, 0.1% to about 10% w/w of polyalkylene oxide block copolymer, 1% to about 10% w/w of a graft copolymer based dispersant and an agriculturally acceptable excipient.

In an embodiment, the present composition discloses a process for preparing an agrochemical composition comprising a triazolone herbicide and at least a second herbicide selected from the group consisting of triketone herbicide, pyrazole herbicide, isoxazole herbicide, or a combination thereof.

In an embodiment, a process for the preparation of an agrochemical composition comprises:
a. mixing a triazolone herbicide and the second herbicide with a crystal growth inhibitor and an agriculturally acceptable excipient
b. milling the resulting mixture to reduce particle size of suspended particles.
c. admixing thickening agents, antifreezing agents, preservatives and optionally other auxiliary ingredients to obtain the composition as described in the present invention.

In an embodiment, the agrochemical composition described herein has a particle size distribution (D50) of less than 10.0 microns. In some embodiments, an agrochemical composition described herein has a particle size distribution (D50) of less than 9.0 microns, less than 8.0 microns, less than 7.0 microns, less than 6.0 microns, less than 4.0 microns, less than 3.0 microns, between 3.0 microns to 5.0 microns, between 2.5 microns to 4.5 microns, or between 2 microns to 5 microns.

In some embodiments, an agrochemical composition described herein has a particle size distribution (D50) of less than 10 μm, preferably 2-5 μm, and D90 of ≤8.5 μm.

In an embodiment, particle size distribution study can be done by methods selected from sieving, sedimentation methods, laser diffraction, dynamic light scattering, image analysis, coulter counter, x-ray sedimentation, centrifugal methods, acoustic spectroscopy, and bet surface area analysis.

Advantageously, the herbicidal composition of the present invention is stable and can be stored for a long period retaining its herbicidal activity and suspensibility and without forming crystals.

In one embodiment, the herbicidal composition of the present invention retains stability when stored at ambient temperatures for 3 months. In a preferred embodiment, the herbicidal composition is stable under AHS conditions that is at 54° C. for two weeks.

In an embodiment, the present invention provides preferred compositions and methods thereof. The methods of the invention include a method of controlling weeds at a locus by applying to the locus the composition, a method of increasing yield in a crop by application of the composition, or a method of improving the plant health by application at the locus of the plant the composition.

The present composition can be applied to the locus of the weeds, in an herbicidally effective amount.

In an embodiment, the composition of the present invention may be combined with at least another active ingredient such as those selected from but not limited to herbicide, insecticide, fungicide, biological agent, plant growth activator, fertilizers or combinations thereof.

In an embodiment, the present disclosure provides use of an herbicidal composition comprising amicarbazone and mesotrione for controlling weeds.

In an embodiment, the present disclosure provides use of an herbicidal composition comprising amicarbazone and topremazone for controlling weeds.

In an embodiment, the composition of the present disclosure is effective in controlling target weeds selected from Alopecurus myosuroides Huds. (blackgrass, ALOMY), Amaranthus palmeri (Palmer amaranth, AMAPA) Amaranthus viridis (slender amaranth, AMAVI), Avena fatua (wild oat, AVEFA), Brachiaria decumbens Stapf, or Urochloa decumbens (Stapf), Brachiaria brizantha or Urochloa brizantha, Brachiaria platyphylla (Groseb.) Nash or Urochloa platyphylla (broadleaf signalgrass, BRAPP), Brachiaria plantaginea. or Urochloa plantaginea (alexandergrass, BRAPL), Cenchrus echinatus (southern sandbur, CENEC), Digitaria horizontalis Willd. (Jamaican crabgrass, DIGHO), Digitaria insularis (sourgrass, TRCIN), Digitaria sanguinalis (large crabgrass, DIGSA), Echinochloa crus-galli (barnyardgrass, ECHCG), Echinochloa colonum (junglerice, ECHCO), Eleusine indica Gaertn. (goosegrass, ELEIN), Lolium multiflorum Lam. (Italian ryegrass, LOLMU), Panicum dichotomiflorum Michx. (fall panicum, PANDI), Panicum miliaceum L. (wild-proso millet, PANMI), Sesbania exaltata (hemp sesbania, SEBEX), Setaria faberi Herrm. (giant foxtail, SETFA), Setaria viridis (green foxtail, SETVI), Sorghum halepense (Johnsongrass, SORHA), Sorghum bicolor, Moench ssp., Arundinaceum (shattercane, SORVU), Cyperus esculentus (yellow nutsedge, CYPES), Cyperus rotundus (purple nutsedge, CYPRO), Abutilon theophrasti (velvetleaf, ABUTH), Amaranthus species (pigweeds and amaranths, AMASS), Ambrosia artemisiifolia L. (common ragweed, AMBEL), Ambrosia psilostachya DC. (western ragweed, AMBPS), Ambrosia trifida (giant ragweed, AMBTR), Anoda cristata (spurred anoda, ANVCR), Asclepias syriaca (common milkweed, ASCSY), Bidens pilosa (hairy beggarticks, BIDPI), Borreria species (BOISS), Borreria alata or Spermacoce alata Aubl. or Spermacoce latifolia (broadleaf buttonweed, BOILF), Chenopodium album L. (common lambsquarters, CHEAL), Cirsium arvense (Canada thistle, CIRAR), Commelina benghalensis (tropical spiderwort, COMBE), Datura stramonium (jimsonweed, DATST), Daucus carota (wild carrot, DAUCA), Euphorbia heterophylla (wild poinsettia, EPHHL), Euphorbia hirta or Chamaesyce hirta (garden spurge, EPHHI), Euphorbia dentata Michx. (toothed spurge, EPHDE), Erigeron bonariensis or Conyza bonariensis (hairy fleabane, ERIBO), Erigeron canadensis or Conyza canadensis (horseweed, ERICA), Conyza sumatrensis (tall fleabane, ERIFL), Helianthus annuus (common sunflower, HELAN), Jacquemontia tamnifolia (smallflower morningglory, IAQTA), Ipomoea hederacea (ivyleaf morningglory, IPOHE), Ipomoea lacunosa (white morningglory, IPOLA), Lactuca serriola (prickly lettuce, LACSE), Portulaca oleracea (common purslane, POROL), Richardia species (pusley, RCHSS), Salsola tragus (Russian thistle, SASKR), Sida species (sida, SIDSS), Sida spinosa (prickly sida, SIDSP), Sinapis arvensis (wild mustard, SINAR), Solanum ptychanthum (eastern black nightshade, SOLPT), Tridax procumbens (coat buttons, TRQPR), Rumex dentatus (RUMDE), Xanthium strumarium (common cocklebur, XANST), Lamium purpureum (LAMPU), Stellaria media (STEME), Cyanus segetum (CENCY), or Galium aparine (GALAP).

In yet another embodiment, the present disclosure provides a method of improving the plant health, the method comprising, applying to the plant or to the locus at which said plant is growing or intended to grow an herbicidal composition as described herein.

According to an embodiment of the present disclosure, there is provided a method of controlling weeds by applying to the plants or to their locus, an agrochemical composition comprising:
a. amicarbazone,
b. mesotrione,
c. an acrylic copolymer, and
d. at least one agriculturally acceptable excipient.

According to an embodiment of the present disclosure, there is provided a method of controlling weeds by applying to the plants or to their locus, an agrochemical composition comprising:
a. amicarbazone,
b. mesotrione,
c. an acrylic copolymer,
d. polyalylene oxide block copolymer,
e. a graft copolymer based dispersant, and
f. at least one agriculturally acceptable excipient.

According to an embodiment of the present disclosure, there is provided a method of controlling weeds by applying to the plants or to their locus, an agrochemical composition comprising:
a. amicarbazone,
b. topremazone,
c. an acrylic copolymer, and
d. at least one agriculturally acceptable excipient.

According to an embodiment of the present disclosure, there is provided a method of controlling weeds by applying to the plants or to their locus, an agrochemical composition comprising:
a. amicarbazone,
b. topremazone,
c. an acrylic copolymer,
d. polyalylene oxide block copolymer,
e. a graft copolymer based dispersant, and
f. at least one agriculturally acceptable excipient.

In one aspect of an embodiment described herein, the triazolone herbicide, such as amicarbazone, is applied in an amount ranging 50 g ai/ha to 250 g ai/ha. In some embodiments, the triazolone herbicide is applied in an amount of 50 g ai/ha, 55 g ai/ha, 60 g ai/ha, 65 g ai/ha, 70 g ai/ha, 75 g ai/ha, 80 g ai/ha, 85 g ai/ha, 90 g ai/ha, 95 g ai/ha, 100 g ai/ha, 105 g ai/ha, 110 g ai/ha, 115 g ai/ha, 120 g ai/ha, 125 g ai/ha, 130 g ai/ha, 135 g ai/ha, 140 g ai/ha, 145 g ai/ha, 150 g ai/ha, 155 g ai/ha, 160 g ai/ha, 164 g ai/ha, 165 g ai/ha, 170 g ai/ha, 175 g ai/ha, 180 g ai/ha, 185 g ai/ha, 190 g ai/ha, 195 g ai/ha, 200 g ai/ha, 205 g ai/ha, 210 g ai/ha, 215 g ai/ha, 220 g ai/ha, 225 g ai/ha, 230 g ai/ha, 235 g ai/ha, 240 g ai/ha, 254 g ai/ha, or 250 g ai/ha, or at a rate within any range defined between any pair of the preceding values, such as, 75 g ai/ha-200 g ai/ha, 100 g ai/ha-200 g ai/ha, or 100 g ai/ha-175 g ai/ha.

In one embodiment described herein, the triketone herbicide, such as mesotrione, is applied at a rate of ranging 25 g ai/ha to 100 g ai/ha. In some embodiments, the triazolone herbicide is applied in an amount of 25 g ai/ha, 30 g ai/ha, 35 g ai/ha, 40 g ai/ha, 45 g ai/ha, 50 g ai/ha, 55 g ai/ha, 60 g ai/ha, 65 g ai/ha, 70.5 g ai/ha, 75 g ai/ha, 80 g ai/ha, 85 g ai/ha, 90 g ai/ha, 95 g ai/ha, or 100 g ai/ha, or at a rate within any range defined between any pair of the preceding values, such as, 10 g ai/ha-90 g ai/ha, 25 g ai/ha-100 g ai/ha, or 40 g ai/ha-85 g ai/ha.

In another embodiment described herein, the pyrazole herbicide, such as topremazone, is applied at a rate of ranging 7.5 g ai/ha to 30 g ai/ha. In some embodiments, the pyrazole herbicide is applied in an amount of 7.5 g ai/ha, 10 g ai/ha, 12.3 g ai/ha, 12.5 g ai/ha, 15 g ai/ha, 17.5 g ai/ha, 20 g ai/ha, 22.5 g ai/ha, 24.6 g ai/ha, 25.0 g ai/ha, 27.5 g ai/ha, 30 g ai/ha, or at a rate within any range defined between any pair of the preceding values, such as, 10 g ai/ha-30 g ai/ha, or 10 g ai/ha-25 g ai/ha.

In yet another embodiment described herein, the isoxazole herbicide, such as isoxaflutole, is applied at a rate of ranging 25 g ai/ha to 100 g ai/ha. In some embodiments, the isoxazole herbicide is applied in an amount of 25 g ai/ha, 30 g ai/ha, 35 g ai/ha, 40 g ai/ha, 45 g ai/ha, 50 g ai/ha, 55 g ai/ha, 60 g ai/ha, 65 g ai/ha, 70.5 g ai/ha, 75 g ai/ha, 80 g ai/ha, 85 g ai/ha, 90 g ai/ha, 95 g ai/ha, or 100 g ai/ha, or at a rate within any range defined between any pair of the preceding

According to an embodiment, the composition according to the present disclosure may be applied either pre or post emergent. The advantage of the composition is surprisingly good residual effects, when applied in pre-emergent as well as quick knockdown when applied post emergent leading to quick control of weeds.

The combinations and the compositions of the present invention may be applied in any known ways or conventional methods known to a person skilled in art. Non-limiting examples of such methods are foliar spray, basal barking, stem injection, drill and fill method, axe cut method, cut stump, cut and swab, stem scraper, wick application and so forth. The compositions of the present invention are used in the customary manner, for example by watering, spraying, atomizing, dusting or scattering.

The compositions of the present invention can be applied to a locus by the use of conventional ground sprayers, granule applicators, watering (drenching), drip irrigation, spraying, atomizing, broadcasting, dusting, foaming, spreading-on, aerial methods of spraying, aerial methods of application, methods utilizing application using modern technologies such as, but not limited to, drones, robots and by other conventional means known to those skilled in the art.

According to an embodiment described herein, the various components of the agrochemical composition can be used individually or already partially or completely mixed with one another to prepare the composition according to the invention. It is also possible for them to be packaged and used further as combination composition such as a kit of parts.

According to an embodiment of the present disclosure, a kit-of-parts comprising an agrochemical composition is provided. The kit comprises a plurality of components, each of which components may include at least one of the ingredients of the agrochemical composition of the present disclosure.

In one embodiment described herein, the kits may include one or more, including all, components that may be used to prepare the agrochemical composition. One or more of the components may already be combined together or pre-formulated. In those embodiments where more than two components are provided in a kit, the components may already be combined together and as such are packaged in a single container such as a vial, bottle, can, pouch, bag or canister.

In other embodiments, two or more components of a kit may be packaged separately, i.e., not pre-formulated. As such, kits may include one or more separate containers such as vials, cans, bottles, pouches, bags or canisters, each container containing a separate component for the agrochemical composition.

In both forms, a component of the kit may be applied separately from or together with the further components or as a component of a combination composition according to one aspect of the embodiment for preparing the agrochemical composition according to the invention.

The present composition obtained has a superior suspensibility, better dispersibility and no sedimentation.

In an embodiment the present compositions have advantageous properties such as resistance management, causing minimal damage to the environment, and a herbicidal composition that has excellent residual effects.

Thus, present invention described herein provides a method of controlling weeds thereby providing resistance management and significant control of the weeds. The invention also provides an adequate method to achieve complete control of weeds, improving yields, while targeting resistance management.

In some embodiments, the present disclosure provides a methods for controlling chlorotriazine resistant or tolerant weeds comprising applying a combination comprising a triazolone herbicide, and at least a second herbicide selected from the group consisting of triketone herbicide, pyrazole herbicide, isoxazole herbicide, or a combination thereof; or an herbicidal composition comprising a triazolone herbicide and a second herbicide selected from the group consisting of triketone herbicide, pyrazole herbicide, isoxazole herbicide, and a combination thereof.

In an embodiment disclosed herein, the chlorotriazine herbicide is atrazine.

In an embodiment the present invention provides a method of controlling the herbicide resistant weeds comprising applying to a locus an herbicidal composition comprising at least one triazolone herbicide and at least one triketone herbicide.

In another embodiment, the method of controlling the herbicide resistant weeds comprising applying to a locus the herbicidal composition comprising amicarbazone and mesotrione.

In some embodiments, the method of controlling the herbicide resistant weeds comprising applying to a locus the herbicidal composition comprising amicarbazone and mesotrione, the herbicide resistant weeds are atrazine resistant weeds.

In some embodiments, the present disclosure provides a method of controlling Amaranthus tuberculatus comprising applying a composition comprising a triazolone herbicide and a triketone herbicide, wherein the triazolone herbicide is amicarbazone and is applied at a rate ranging from about 100 g ai/ha to about 175 g ai/ha and the triketone herbicide is mesotrione and applied at a rate ranging from about 50 g ai/ha to about 85 g ai/ha.

In another embodiments, the present disclosure provides a method of controlling Abutilon theophrasti comprising applying a composition comprising a triazolone herbicide and a triketone herbicide, wherein the triazolone herbicide is amicarbazone and is applied at a rate ranging from about 100 g ai/ha to about 175 g ai/ha and the triketone herbicide is mesotrione and applied at a rate ranging from about 50 g ai/ha to about 85 g ai/ha.

In another embodiments, the instant disclosure provides a method of controlling Sataria faberi comprising applying a composition comprising a triazolone herbicide and a triketone herbicide, wherein the triazolone herbicide is amicarbazone and is applied at a rate ranging from about 100 g ai/ha to about 175 g ai/ha and the triketone herbicide is mesotrione and applied at a rate ranging from about 50 g ai/ha to about 85 g ai/ha.

In some embodiments, the present disclosure provides a method of controlling Amaranthus tuberculatus comprising applying a combination comprising a triazolone herbicide and a pyrazole herbicide, wherein the triazolone herbicide is amicarbazone and is applied at a rate ranging from about 100 g ai/ha to about 175 g ai/ha and the pyrazole herbicide is topremazone and applied at a rate ranging from about 10 g ai/ha to about 25 g ai/ha.

In another embodiments, the present disclosure provides a method of controlling Abutilon theophrasti comprising applying a combination comprising a triazolone herbicide and a pyrazole herbicide, wherein the triazolone herbicide is amicarbazone and is applied at a rate ranging from about 100 g ai/ha to about 175 g ai/ha and the pyrazole herbicide is topremazone and applied at a rate ranging from about 10 g ai/ha to about 25 g ai/ha.

In another embodiments, the instant disclosure provides a method of controlling Sataria faberi comprising applying a combination comprising a triazolone herbicide and a pyrazole herbicide, wherein the triazolone herbicide is amicarbazone and is applied at a rate ranging from about 100 g ai/ha to about 175 g ai/ha and the pyrazole herbicide is topremazone and applied at a rate ranging from about 10 g ai/ha to about 25 g ai/ha.

All the features described herein may be combined with any of the above aspects or any of above-described embodiment, in any combination.

These representative embodiments are in no way limiting and are described solely to illustrate some aspects of the invention. Further, the following examples are offered by way of illustration only and not by way of limitation.

### EXAMPLES

### Example 1

TABLE 1
Formulation 1: Amicarbazone +
Mesotrione Suspension concentrate (SC)

| | | QUANTITY IN |
|---|---|---|
| S. NO. | INGREDIENTS | % (w/w) |
| 1 | Amicarbazone | 25-35% |
| 2 | Mesotrione | 10 to 20% |
| 3 | Crystal growth inhibitor | 1 to 20% |
| 4 | Agriculturally acceptable | 0.1 to 60% |
| | excipient | |
| 5 | Water | QS |
| | Total | 100 |

### Example 2

TABLE 2
Formulation 2: Amicarbazone +
Mesotrione Suspension concentrate (SC)

| | | QUANTITY IN |
|---|---|---|
| S. NO. | INGREDIENTS | % (w/w) |
| 1 | Amicarbazone | 28.77 |
| 2 | Mesotrione | 14.22 |
| 3 | Non-ionic wetting agent | 1.20 |
| 4 | Graft copolymer | 3.22 |
| 5 | Ethoxylated phosphate | 1.08 |
| | ester | |
| 6 | Biocide | 0.20 |
| 7 | Silicone antifoam | 0.20 |
| | emulsion | |
| 8 | Xanthan gum | 0.15 |
| 9 | Propane-1,2,3-triol | 5 |
| 10 | Water | QS |
| | Total | 100 |

amicarbazone (97.8%), mesotrione (98.5%), non-ionic wetting agent, graft co-polymer, ethoxylated phosphate ester, biocide, silicone antifoam emulsion, xanthan gum, propane-1,2,3-triol, and sufficient quantity of water were charged in quantities mentioned in the above table in a homogenizer. Homogenization was carried out for 1 hour 30 minutes to obtain homogenized mixture. The homogenized mixture was then fed to the wet grinding mill for particle size reduction.

The uniform mixture thus obtained in milling was then mixed in gellification vessel containing pre-formulated 1.5% gel to obtain suspension concentrate.

### Stability Study Data:

Stability features associated with the formulation developed according to the process described herein were studied. Formulation 2 was evaluated for physicochemical parameters and the corresponding data is highlighted in Table 3 below. It was found that the formulation remained stable when tested at ambient conditions, i.e., room temperature and pressure. The composition also passed 14 days Accelerated Heat Stability (AHS) test and remained flowable suspension in off-white appearance. Amount of active content was also evaluated at ambient and AHS stages. It was found that active content remained almost constant without any significant deterioration or loss. The compositions also passed wet sieve testing as no crystals were observed to be retained on wet sieve. Particle size of composition was analyzed and found to be nearly constant suggesting little/negligible particle size growth or crystal formation.

TABLE 3

| | | | | 1 week | | |
|---|---|---|---|---|---|---|
| Time Point | | Initial | 2 weeks | F/T | 2 months | 3 months |
| Condition | | RT | 54° C. | −10° C./25° C. | 40° C. | RT |
| Appearance | | Off- | Yellowish | Off-White | Off-White | Off-White |
| | | White | Off-white | Liquid, | Liquid | Liquid |
| | | Liquid | Liquid | thaws back | w/19% | w/2% |
| | | | w/6% | within 2 | Syneresis | Syneresis |
| | | | Syneresis | hours | | |
| Viscosity (cP) | | 264 | 490 | 278 | 228 | 210 |
| (#3, 60 rpm) | | | | | | |
| Density g/ml | | 1.1196 | 1.12 | 1.12 | 1.12 | 1.12 |
| pH (1% DI) | | 3.64 | 3.74 | 3.61 | 3.26 | 3.55 |
| Particle | D50 | 2.707 | 3.04 | | 3.068 | 2.754 |
| Size | D90 | 7.15 | 8.234 | | 7.823 | 7.222 |
| Wet sieve | 100 Mesh | 0.00% | 0.02% | 0.00% | 0.01% | 0.00% |
| Retention | 325 Mesh | 0.00% | 0.00% | 0.00% | 0.03% | 0.00% |

| | | | | | |
|---|---|---|---|---|---|
| % Suspensibility | 101.50% | 98.55% | N/A | 99.52% | 103.41% |
| (>80%) | | | | | |

### Example 3

TABLE 4
Formulation 3: Amicarbazone +
Mesotrione Suspension concentrate (SC)

| | | QUANTITY IN |
|---|---|---|
| S. NO. | INGREDIENTS | % (w/w) |
| 1 | Amicarbazone | 31.57 |
| 2 | Mesotrione | 12.55 |
| 3 | acrylic copolymer | 1.20 |
| 4 | Graft copolymer | 3.22 |
| 5 | Ethoxylated phosphate | 1.08 |
| | ester | |
| 6 | Biocide | 0.20 |
| 7 | Silicone antifoam | 0.20 |
| | emulsion | |
| 8 | Xanthan gum | 0.16 |
| 9 | Propane-1,2,3-triol | 5.00 |
| 10 | Water | QS |
| | Total | 100 |

amicarbazone (97.8%), mesotrione (98.5%), acrylic copolymer, graft co-polymer, ethoxylated phosphate ester, biocide, silicone antifoam emulsion, xanthan gum, propane-1,2,3-triol, and sufficient quantity of water were charged in quantities mentioned in the above table in a homogenizer. Homogenization was carried out for 1 hour 30 minutes to obtain homogenized mixture. The homogenized mixture was then fed to the wet grinding mill for particle size reduction. The uniform mixture thus obtained in milling was then mixed in gellification vessel containing pre-formulated 1.5% gel to obtain suspension concentrate.

### Stability Study Data:

Stability features associated with the formulation developed according to the process described herein were studied. Formulation 3 was evaluated for physicochemical parameters and the corresponding data is highlighted in Table 5 below. It was found that the formulation remained stable when tested at ambient conditions, i.e., room temperature and pressure. The composition also passed 14 days Accelerated Heat Stability (AHS) test and remained flowable suspension in off-white appearance. Amount of active content was also evaluated at ambient and AHS stages. It was found that active content remained almost constant without any significant deterioration or loss. The compositions also passed wet sieve testing as no crystals were observed to be retained on wet sieve. Particle size of composition was analyzed and found to be nearly constant suggesting little/negligible particle size growth or crystal formation.

TABLE 5

| | | | | 1 week | | |
|---|---|---|---|---|---|---|
| Time Point | | Initial | 2 weeks | F/T | 2 months | 3 months |
| Condition | | RT | 54° C. | −10° C./25° C. | 40° C. | RT |
| Appearance | | Off-White | Yellowish | Off-White | Off-White | Off-White |
| | | Liquid | Off-white | Liquid, | Liquid | Liquid |
| | | | Liquid | thaws back | w/19% | w/2% |
| | | | w/3% | within 2 | Syneresis | Syneresis |
| | | | Syneresis | hours | | |
| Viscosity (cP) | | 266 | 202 | 270 | 246 | 215 |
| (#3, 60 rpm) | | | | | | |
| Density g/ml | | 1.113 | 1.11 | 1.11 | 1.11 | 1.11 |
| pH (1% DI) | | 3 | 3.11 | 3.02 | 3.12 | 3.05 |
| Particle | 2.64 | 3.103 | | 2.995 | 2.702 | 2.754 |
| Size | 7.096 | 7.558 | | 7.264 | 7.16 | 7.222 |
| Wet sieve | 0.00% | 0.01% | 0.00% | 0.00% | 0.00% | 0.00% |
| Retention | 0.00% | 0.01% | 0.00% | 0.00% | 0.00% | 0.00% |

| | | | | | |
|---|---|---|---|---|---|
| % Suspensibility | 105.39% | 102.22% | N/A | 98.44% | 102.36% |
| (>80%) | | | | | |

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention.

We claim:

1. A herbicidal composition comprising:
a. amicarbazone;
b. at least a second herbicide selected from mesotrione, topramezone, and isoxaflutole;
c. at least one crystal growth inhibitor; and
d. at least an agriculturally acceptable excipient.

2. The composition as claimed in claim 1, wherein the crystal growth inhibitor comprises an acrylic copolymer.

3. The composition as claimed in claim 2, wherein the crystal growth inhibitor concentration is from about 1% w/w to about 20% w/w of the total weight of the formulation.

4. The composition as claimed in claim 1, wherein agriculturally acceptable excipient is selected from the group consisting of surfactants, wetting agents, antifreezing agents, diluents, solvents, stabilizers, thickeners, preservatives, biocides, antifoaming agents, and a combination thereof.

5. The composition as claimed in claim 4, wherein surfactant is selected from graft copolymers, polyalkylene oxide block copolymer or a combination thereof.

6. The composition as claimed in claim 5, wherein graft copolymer and polyalkylene oxide block copolymers are present in an amount from about 1% w/w to about 10% w/w of the total weight of the composition.

7. The composition as claimed in claim 1, wherein the ratio of amicarbazone to the second herbicide is in the range from about 1:10 to 10:1.

8. The composition as claimed in claim 1, wherein amicarbazone concentration is from about 10% w/w to about 50% w/w and the second herbicide concentration is from about 5% w/w to about 20% w/w.

9. The composition as claimed in claim 1, having a particle size distribution (D50) of less than 10 μm, preferably 2-5 μm, and D90 of ≤8.5 μm.

10. The composition as claimed in claim 1, wherein the composition is a suspension concentrate.

11. A method of controlling weeds at a locus by applying a composition according to claim 1 in an herbicidally effective amount, pre- or post-emergence of the weeds.

12. The method of claim 11, wherein amicarbazone is applied at 50-250 g ai/ha and the second herbicide at 25-100 g ai/ha.
